(19) United States
(12) Patent Application Publication
(10) Pub. No.: US 2010/0299757 A1
(43) Pub. Date: Nov. 25, 2010

(54) MOBILE TERMINAL FOR INFORMATION SECURITY AND INFORMATION SECURITY METHOD OF MOBILE TERMINAL

(76) Inventor: Ho Sub LEE, Seoul (KR)

Correspondence Address: North Star Intellectual Property Law, PC, P.O. Box 34688, Washington, DC, 20043, US

(21) Appl. No.: 12/706,023

(22) Filed: Feb. 16, 2010

(30) Foreign Application Priority Data
May 21, 2009 (KR) 10-2009-0044372

(51) Int. Cl. G06F 7/04

(52) U.S. Cl. 726/26

(57) ABSTRACT

A mobile terminal to secure information stored therein is provided. The mobile terminal may perform an algorithm to perform information security without remote control. The mobile terminal may detect a characteristic behavior pattern of a user of the mobile terminal, compare the characteristic behavior pattern with a behavior pattern of a current user, and thereby may determine whether a current user is an authorized user. Also, the mobile terminal may perform processing to protect data stored in the mobile terminal based on a result of the determination.

### CROSS-REFERENCE TO RELATED APPLICATION

This application claims the benefit under 35 U.S.C. §119(a) of a Korean Patent Application No. 10-2009-0044372, filed on May 21, 2009, in the Korean Intellectual Property Office, the entire disclosure of which is incorporated herein by reference for all purposes.

### BACKGROUND

1. Field

The following description relates to a technology to protect information stored in a terminal, and more particularly, to a technology to protect information stored in a mobile terminal in the event of an emergency such as loss or theft of the mobile terminal.

2. Description of the Related Art

Currently, various mobile terminals such as a cellular phone, a Personal Digital Assistant (PDA), a Portable Multimedia Player (PMP), and the like are widely used. A user may store various types of data or information in a mobile terminal. For example, a user may store photos, music files, data of a telephone book, text messages, etc., in a cellular phone.

When a user loses the mobile terminal or has it stolen, the user's privacy may be compromised if confidential information was stored thereon. Furthermore, where information stored in a mobile terminal is used by a company or a government employee, a significant amount of damage may be caused if the otherwise secure information is available to an unauthorized user.

In response to this issue, a variety of methods to protect information stored in a mobile terminal have been attempted. For example, security technologies include functions to activate a mobile terminal only when a password is input, technologies to remotely control a lost or stolen mobile terminal to protect information stored in the mobile terminal, etc. However, a mobile terminal having the above technologies may be operated manually and by an unauthorized user if the unauthorized user has access to the true mobile terminal owner's password. Accordingly, such technologies may not effectively protect information stored in a mobile terminal where a user does not know that the mobile terminal has been lost or stolen.

### SUMMARY

In one general aspect, there is provided an information security method in a mobile terminal, the information security method includes collecting data associated with a characteristic behavior pattern of a user of the mobile terminal, comparing the characteristic behavior pattern with a behavior pattern of the user with respect to the mobile terminal, the behavior pattern being monitored in a particular time period, and performing processing to protect data stored in the mobile terminal based on a result of the comparison.

The performing may include hiding or deleting the data stored in the mobile terminal, or transmitting a notification message, associated with a current state or a current location of the mobile terminal, to an outside of the mobile terminal.

The collecting may collect the data associated with the characteristic behavior pattern of the user to update the characteristic behavior pattern.

The information security method may further include detecting the characteristic behavior pattern of the user based on the collected data.

The information security method may further include monitoring the mobile terminal in real time to detect the behavior pattern of the user with respect to the mobile terminal, the behavior pattern of the user being monitored in the particular time period.

The comparing may compare a value corresponding to the characteristic behavior pattern of the user with a value corresponding to the behavior pattern of the user to compare the characteristic behavior pattern with the behavior pattern of the user.

The performing may perform processing to protect data, which is requested to be protected in advance, from among the data stored in the mobile terminal.

The characteristic behavior pattern of the user may include a characteristic usage pattern of the user with respect to the mobile terminal or a characteristic environmental change pattern around the mobile terminal.

The characteristic behavior pattern of the user may include a characteristic usage pattern of the user with respect to the mobile terminal, and the characteristic usage pattern may be detected based on details of calls of the user, a history of access to the Internet, a history of sending/receiving a text message, keystroke information, and a history of application uses.

The characteristic behavior pattern of the user includes a characteristic environmental pattern of the user with respect to the mobile terminal, and the characteristic environmental change pattern may be detected based on at least one of a moving route of the mobile terminal, information about the environment of the mobile terminal, and biological information of the user.

In another general aspect, there is provided a computer-readable storage medium to store a program to implement an information security method in a mobile terminal, comprising instructions causing a computer to collect data associated with a characteristic behavior pattern of a user of the mobile terminal, compare the characteristic behavior pattern with a behavior pattern of the user with respect to the mobile terminal, the behavior pattern being monitored in a particular time period, and perform processing to protect data stored in the mobile terminal based on a result of the comparison.

In another general aspect, there is provided a mobile terminal to secure information stored therein, the mobile terminal includes a database to collect data associated with a characteristic behavior pattern of a user of the mobile terminal, a monitoring unit to detect the characteristic behavior pattern of the user using the database, a pattern comparison/reasoning unit to compare the characteristic behavior pattern with a behavior pattern of the user with respect to the mobile terminal, the behavior pattern being monitored in a particular time period, and a post-processing unit to perform processing to protect data stored in the mobile terminal based on a result of the comparison.

The post-processing unit may include at least one of a data management unit to hide or delete the data stored in the mobile terminal, and an urgent communication unit to transmit a notification message, associated with a current state or a current location of the mobile terminal, to an outside of the mobile terminal.

The monitoring unit may monitor the mobile terminal in real time to detect the behavior pattern of the user with respect to the mobile terminal, the behavior pattern of the user being monitored in the particular time period.

Other features and aspects will be apparent from the following detailed description, the drawings, and the claims.

### BRIEF DESCRIPTION OF THE DRAWINGS

FIG. 1 is a diagram illustrating examples of a mobile terminal and various types of data stored in the mobile terminal.

FIG. 2 is a diagram illustrating an example of a mobile terminal to detect a characteristic behavior pattern of a user and to check whether a current user is an authorized user using the detected characteristic behavior pattern in real time.

FIG. 3 is a flowchart illustrating an example of an information security method.

FIG. 4 is a diagram illustrating an example of data used during detection of a characteristic behavior pattern.

FIG. 5 is a block diagram illustrating a configuration of an example of a mobile terminal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, descriptions of well-known functions and constructions may be omitted for increased clarity and conciseness.

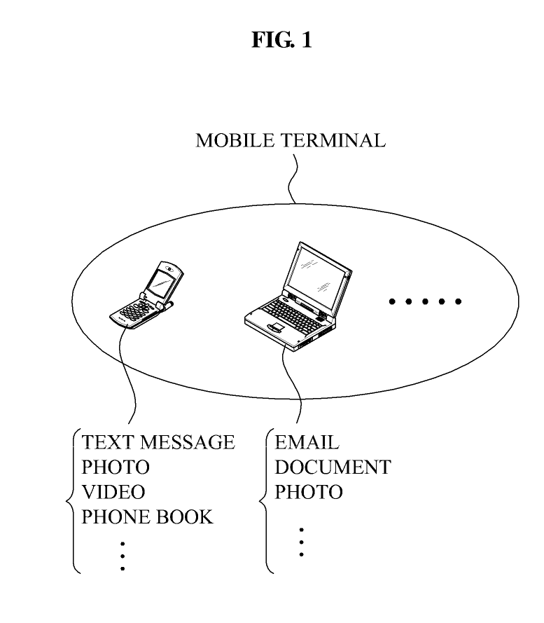

FIG. 1 illustrates examples of a mobile terminal and various types of data stored in the mobile terminal.

Referring to FIG. 1, various types of data may be stored in the mobile terminal, which may include various types of devices such as a cellular phone, a notebook computer (i.e. laptop), and the like. For example, as illustrated in FIG. 1, private information such as text messages, photo and video files, phone book, and the like, may be stored in the cellular phone. Also, emails, various documents, photos, and the like may be stored in the notebook computer.

If the information stored in the mobile terminal is easily revealed and unsecure, a user's private information may be compromised thereby resulting in potentially substantial financial damage. In particular, if the user's mobile terminal is stolen, the user loses control the mobile terminal and all of the information stored thereupon. Furthermore, conventional methods of password-protecting mobile terminals may be difficult, inconvenient, and cumbersome.

A user's mobile terminal usage behavior such as calling, sending and/or receiving text messages, movement, and application uses, may have a particular pattern. For example, the user of the mobile terminal generally moves along a particular moving route, talks on the mobile terminal with a particular caller and a particular receiver, and uses particular applications from among a plurality of applications installed in the mobile terminal. A characteristic behavior pattern of the user may be detected from the above-described behavior patterns of the user.

Accordingly, the mobile terminal may actively ascertain a loss or theft of the mobile terminal using the detected user's characteristic behavior pattern, without remote control. For example, where a behavior of a current user is significantly different from the characteristic behavior pattern of the user, the mobile terminal may determine that the current user is an unauthorized user, and recognize that the mobile terminal is lost or stolen. An operation of actively and intelligently recognizing the loss or theft is described in detail below.

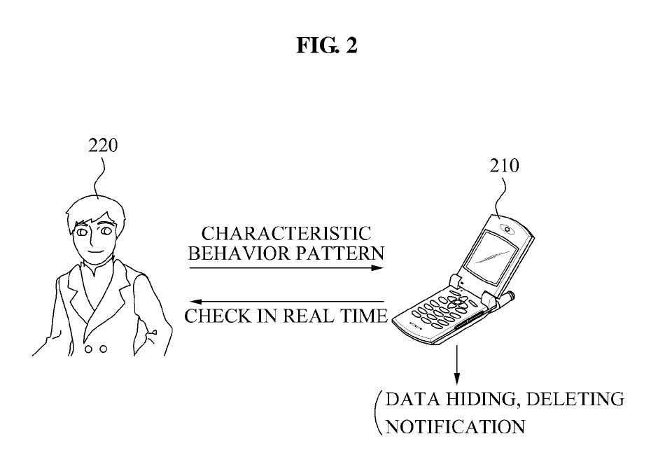

FIG. 2 illustrates an example of a mobile terminal 210 to detect a characteristic behavior pattern of a user 220 and to check whether a current user is an authorized user using the detected characteristic behavior pattern in real time.

Referring to FIG. 2, the mobile terminal 210 may recognize the characteristic behavior pattern of the user 220 from among various behaviors of the user 220. Accordingly, the characteristic behavior pattern of the user 220 may be classified into a characteristic usage pattern of the user 220 and a characteristic change pattern of an environment of the mobile terminal 210.

The characteristic behavior pattern of the user 220 may be detected based on details regarding calls the user 220 has made and/or received, a history of access to the Internet, a history of sending and/or receiving text messages, keystroke information, and a history of application uses. The details of the calls of the user 220 may include information about a caller, information about a receiver, a time of making the calls, a time of receiving the calls, and a call duration. The history of sending and/or receiving the text messages may include information about a caller, information about a receiver, a size of the text message, a time of sending, a time of receiving, and the like. Also, the keystroke information of the user 220 may include information about a strength and/or speed of the manner in which keys were input. The history of application uses may include information about a type and/or time of use of a particular application which is installed in the mobile terminal 210.

Also, the characteristic change pattern of the environment of the mobile terminal 210 may be influenced by external factors. That is, the characteristic change pattern of the environment of the mobile terminal 210 may be detected based on at least one of a moving route of the mobile terminal 210, information about the environment of the mobile terminal 210, and biological information of the user 220. More specifically, the information about the environment may include a brightness of a location of the mobile terminal 210, a humidity level of the location of the mobile terminal 210, a noise level of the location of the mobile terminal 210, etc., and the biological information may include a body temperature of the user, etc.

The mobile terminal 210 may check whether the current user is the authorized user 220 in real time, after detecting the characteristic behavior pattern of the user 220 from the behaviors of the user 220. That is, the mobile terminal 210 may determine whether a behavior pattern, detected from the behavior of the current user, is similar to the characteristic behavior pattern of the user 220, and thereby may check whether the current user is the authorized user 220. As a similarity between the detected behavior pattern of the current user and the characteristic behavior pattern of the user 220 decreases, a probability that the current user may be an unauthorized user increases.

Where the current user is an unauthorized user, the mobile terminal 210 may actively hide or delete data in order to protect the mobile terminal 210's true owner (i.e., the user 220 as illustrated in FIG. 2). In this instance, the data actively hidden or deleted may be set by the user 220 in advance.

Also, the mobile terminal 210 may report the loss or theft of the mobile terminal 210 and transmit a notification message to a location outside of the mobile terminal 210, such as a serving base station. The notification message may include a current location of the mobile terminal 210.

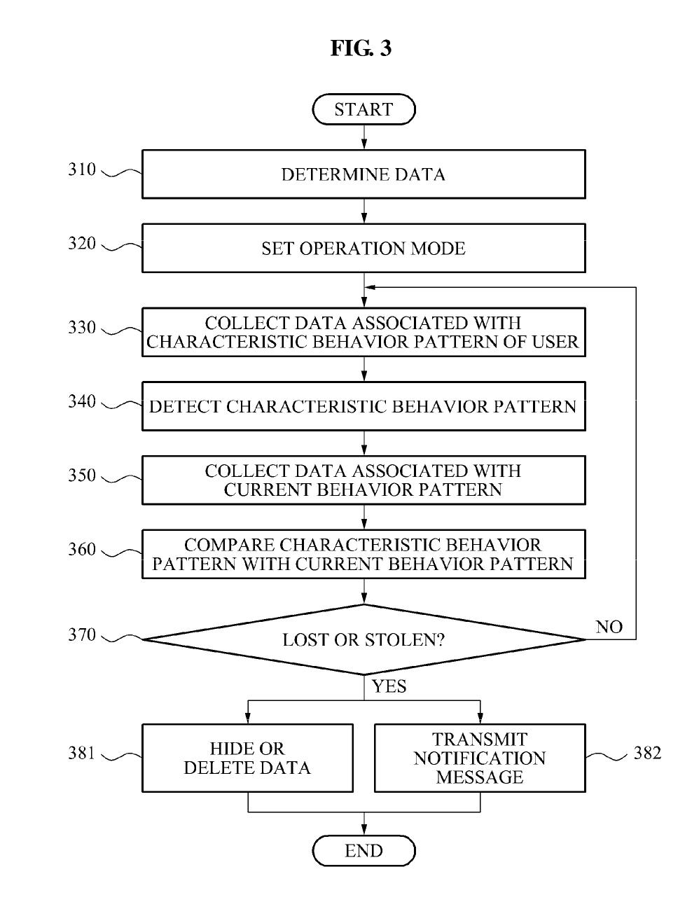

FIG. 3 illustrates an example of an information security method.

The information security method may be actively and intelligently performed.

Referring to FIG. 3, at 310, the information security method may identify data, which is requested to be protected by a user, from among data stored in a mobile terminal. In this instance, the user may request data associated with privacy, valuable data, and the like, to be protected in advance.

At 320, the information security method may set an operation mode corresponding to a loss or theft of the mobile terminal according to a user setting. For example, if the mobile terminal is lost or stolen, the user may desire a mode of hiding or deleting the data to be protected, and select a mode of transmitting a notification message.

At 330, the information security method may collect data associated with a characteristic behavior pattern of the user of the mobile terminal. In this instance, the mobile terminal may continuously collect details of calls of the user, a history of access to the Internet, a history of sending and/or receiving text messages, keystroke information, and a history of application uses. Accordingly, the application may be installed in the mobile terminal. Also, the mobile terminal may collect at least one of information about a moving route of the mobile terminal, information about an environment of the mobile terminal, and biological information of the user. The information about the environment may include a brightness of a location of the mobile terminal, a humidity level of the location of the mobile terminal, a noise level of the location of the mobile terminal, and, and the biological information may include a body temperature of the user, etc.

At 340, the information security method may detect the characteristic behavior pattern of the user based on the collected data. In this instance, a variety of well-known data analysis schemes may be applied, and the characteristic behavior pattern may be expressed numerically or in a table or a graph.

At 350, the information security method may collect data to detect a current behavior pattern of a user of the mobile terminal in real time.

At 360, the information security method may compare the characteristic behavior pattern, detected at 340, with the behavior pattern, detected at 350.

At 370, the information security method may determine whether the current user is an authorized user or whether the mobile terminal is lost or stolen, based on a result of the comparison at 360.

That is, where the behavior pattern, detected at 350, is significantly different from the characteristic behavior pattern, detected at 340, the information security method may determine that the current user is an unauthorized user. Conversely, where the behavior pattern, detected at 350, is significantly similar to the characteristic behavior pattern, detected at 340, the information security method may determine that the current user is an authorized user.

Where the current user is in fact the authorized user, the information security method may return to 330. However, where the current user is the unauthorized user, the information security method may perform at least one of transmitting data (at 382) and deleting or hiding data (at 381).

At 381, the information security method may hide or delete the data to be protected. At 382, the information security method may transmit the notification message to an outside location of the mobile terminal.

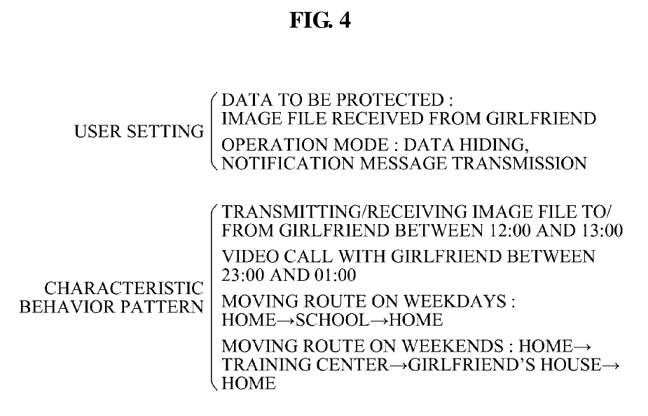

FIG. 4 illustrates an example of data used during detection of a characteristic behavior pattern.

The examples of data to be protected and an operation mode are illustrated in FIG. 4. That is, a user may determine an image file, received from a girlfriend (for example), as the data to be protected. Also, the data to be protected may be set by the user, and the user may set a mode of hiding the data to be protected and a mode of transmitting a notification message in an event of loss or theft of the mobile terminal, as the operation mode.

The user may behave according to the characteristic behavior pattern as illustrated in FIG. 4. That is, the user may send and/or receive an image file from and/or to the girlfriend between 12:00 and 13:00, and perform a video call with the girlfriend between 23:00 and 01:00. Also, the user usually moves along a route of home—school—home on weekdays, and along a route of home—training center—girlfriend's house—home on weekends. The above-described behaviors may be automatically monitored by the mobile terminal, and the mobile terminal may detect the characteristic behavior pattern using data associated with the collected behaviors of the user. Accordingly, the characteristic behavior pattern may be expressed in various ways such as a table, a numerical value, a graph, and the like.

For example, it may be assumed that the user lost the mobile terminal in a bus while going to school on Wednesday morning, and the user does not realize it. Accordingly, the mobile terminal lost on the bus may continuously monitor a behavior pattern of a user of the mobile terminal.

Hence, the mobile terminal moves along a route of the bus, and the user does not send and/or receive an image file between 12:00 and 13:00, and a monitored noise around the mobile terminal may be higher than usual.

In this instance, the mobile terminal may determine that the current situation around the mobile terminal is different from typical patterns by means of the characteristic behavior pattern based on the collected data. In particular, the mobile terminal may compare a value corresponding to the characteristic behavior pattern with a value corresponding to the current situation around the mobile terminal, and apply a result of the comparison to a particular rule, and thereby may determine that the current situation around the mobile terminal is different from the characteristic behavior pattern.

As a result, the mobile terminal may hide the image file received from the girlfriend, which is the data to be protected, and transmit the notification message. Accordingly, although the user may not recognize the loss or theft of the mobile terminal, the data will be protected. Also, the data may be efficiently protected even when a communication of the mobile terminal is unavailable, since remote control is not required.

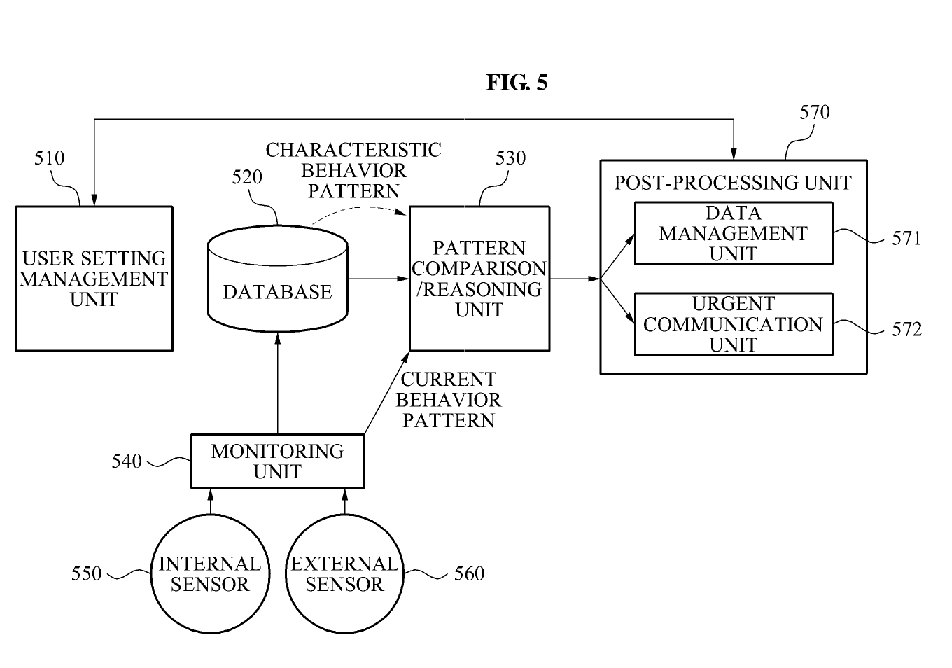

FIG. 5 illustrates a configuration of an example of a mobile terminal.

Referring to FIG. 5, the mobile terminal includes a user setting management unit 510, a database 520, a pattern comparison/reasoning unit 530, a monitoring unit 540, an internal sensor 550, an external sensor 560, and a post-processing unit 570.

The user setting management unit 510 may manage a user setting with respect to data to be protected, and an operation mode if the mobile terminal is lost or stolen. The data to be protected may be requested by a user.

The database 520 may store the characteristic behavior pattern of the user based on the collected data associated with a characteristic behavior pattern of a user of the mobile terminal. This behavior pattern is provided from the monitoring unit 540. In this instance, the database 520 may update the characteristic behavior pattern.

Also, the pattern comparison/reasoning unit 530 may compare the characteristic behavior pattern with a behavior pattern of the user with respect to the mobile terminal. The behavior pattern may be monitored in a particular time period. Also, the pattern comparison/reasoning unit 530 may apply a result of the comparison to a particular rule, and thereby may identify a current state of the mobile terminal.

Also, the monitoring unit 540 may monitor data, provided from the internal sensor 550 and the external sensor 560, in real time and detect the behavior pattern of the user with respect to the mobile terminal based on the data. Also, the monitoring unit 540 may provide the detected behavior pattern to the database 520 and the pattern comparison/reasoning unit 530. Accordingly, the internal sensor 550 may provide, to the monitoring unit 540, details of calls of the user, a history of access to the Internet, a history of sending/receiving text messages, keystroke information, and a history of application uses in real time. Also, the external sensor 560 may provide, to the monitoring unit 540, a moving route of the mobile terminal, information about an environment of the mobile terminal, and biological information of the user.

The post-processing unit 570 includes a data management unit 571 and an urgent communication unit 572. In this instance, the data management unit 571 may hide or delete the data stored in the mobile terminal based on the user setting, and the urgent communication unit 572 may transmit a notification message, associated with a current state or a current location of the mobile terminal, to a location outside of the mobile terminal.

Since the descriptions described with reference to FIGS. 1 through 4 may be applied to the above-described units illustrated in FIG. 5, further detailed descriptions will be omitted herein.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As described above with reference to the figures, a mobile terminal may actively or intelligently determine whether the mobile terminal is lost or stolen, or whether a current user is an authorized user, and thereby may efficiently protect information, stored in the mobile terminal, even when the user does not recognize the loss or theft.

Also as described above with reference to the figures, a mobile terminal may compare a characteristic behavior pattern of a user with a current behavior pattern, and thereby may accurately determine whether the mobile terminal is lost or stolen or whether a current user is an authorized user.

Further as described above with reference to the figures, a mobile terminal may actively or intelligently determine whether the mobile terminal is lost or stolen, or whether a current user is an authorized user, and thereby may economically protect information, stored in the mobile terminal, without a separate hardware for remote control.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An information security method in a mobile terminal, the information security method comprising:
collecting data associated with a characteristic behavior pattern of a user of the mobile terminal;
comparing the characteristic behavior pattern with a behavior pattern of the user with respect to the mobile terminal, the behavior pattern being monitored in a particular time period; and
performing processing to protect data stored in the mobile terminal based on a result of the comparison.

2. The information security method of claim 1, wherein the performing comprises:
hiding or deleting the data stored in the mobile terminal.

3. The information security method of claim 1, wherein the performing comprises:
transmitting a notification message, associated with a current state or a current location of the mobile terminal, to an outside of the mobile terminal.

4. The information security method of claim 1, wherein the collecting collects the data associated with the characteristic behavior pattern of the user to update the characteristic behavior pattern.

5. The information security method of claim 1, further comprising:
detecting the characteristic behavior pattern of the user based on the collected data.

6. The information security method of claim 1, further comprising:
monitoring the mobile terminal in real time to detect the behavior pattern of the user with respect to the mobile terminal, the behavior pattern of the user being monitored in the particular time period.

7. The information security method of claim 1, wherein the comparing compares a value corresponding to the characteristic behavior pattern of the user with a value corresponding to the behavior pattern of the user to compare the characteristic behavior pattern with the behavior pattern of the user.

8. The information security method of claim 1, wherein the performing performs processing to protect data, which is requested to be protected in advance, from among the data stored in the mobile terminal.

9. The information security method of claim 1, wherein the characteristic behavior pattern of the user includes a characteristic usage pattern of the user with respect to the mobile terminal or a characteristic change pattern of an environment of the mobile terminal.

10. The information security method of claim 1, wherein the characteristic behavior pattern of the user includes a characteristic usage pattern of the user with respect to the mobile terminal, and the characteristic usage pattern is detected based on at least one of details of calls of the user, a history of access to the Internet, a history of sending and/or receiving a text message, keystroke information, and a history of application uses.

11. The information security method of claim 1, wherein the characteristic behavior pattern of the user includes a characteristic change pattern of an environment of the mobile terminal, and the characteristic change pattern is detected based on at least one of a moving route of the mobile terminal, information about the environment of the mobile terminal, and biological information of the user.

12. A computer-readable storage medium to store a program to implement an information security method in a mobile terminal, comprising instructions causing a computer to:
collect data associated with a characteristic behavior pattern of a user of the mobile terminal;
compare the characteristic behavior pattern with a behavior pattern of the user with respect to the mobile terminal, the behavior pattern being monitored in a particular time period; and
perform processing to protect data stored in the mobile terminal based on a result of the comparison.

13. A mobile terminal to secure information stored therein, the mobile terminal comprising:
a database to collect data associated with a characteristic behavior pattern of a user of the mobile terminal;
a monitoring unit to detect the characteristic behavior pattern of the user using the database;
a pattern comparison/reasoning unit to compare the characteristic behavior pattern with a behavior pattern of the user with respect to the mobile terminal, the behavior pattern being monitored in a particular time period; and
a post-processing unit to perform processing to protect data stored in the mobile terminal based on a result of the comparison.

14. The mobile terminal of claim 13, wherein the post-processing unit comprises at least one of a data management unit to hide or delete the data stored in the mobile terminal, and an urgent communication unit to transmit a notification message, associated with a current state or a current location of the mobile terminal, to an outside of the mobile terminal.

15. The mobile terminal of claim 13, wherein the monitoring unit monitors the mobile terminal in real time to detect the behavior pattern of the user with respect to the mobile terminal, the behavior pattern of the user being monitored in the particular time period.
